(19) United States
(12) Patent Application Publication
(10) Pub. No.: US 2012/0281066 A1
(43) Pub. Date: Nov. 8, 2012

(54) INFORMATION PROCESSING DEVICE AND INFORMATION PROCESSING METHOD

(75) Inventor: Toshiro OHBITSU, Kawasaki (JP)

(73) Assignee: FUJITSU LIMITED, Kawasaki-shi (JP)

(21) Appl. No.: 13/435,979

(22) Filed: Mar. 30, 2012

(30) Foreign Application Priority Data
May 6, 2011 (JP) 2011-103589

(51) Int. Cl. H04N 13/04

(52) U.S. Cl. 348/43; 348/E13.026

(57) ABSTRACT

An information processing device comprising, a receiving unit to receive image data; a determining unit to determine whether the image data received by the receiving unit contain an image for three dimensional vision or not; a converting unit to convert, if the determining unit determines that the image data contain the image for the three dimensional vision, the image data into a stereoscopic image; and a display unit to display the stereoscopic image converted by the converting unit.

### CROSS-REFERENCE TO RELATED APPLICATION

This application is based upon and claims the benefit of priority of the prior Japanese Patent Application No. 2011-103589 filed on May 6, 2011, the entire contents of which are incorporated herein by reference.

### FIELD

The present invention relates to an information processing device, an information processing method and an information processing program.

### BACKGROUND

There is a spread of network services based on an IP (Internet Protocol) network such as the Internet and a LAN (Local Area Network). Further, with a larger capacity of a network line, the services using data, which involve a large quantity of communication data, start being provided.

There is a service called a video chat (an image chat, a moving picture chat) to do chatting between a plurality of computers while looking at images of communication partner users that are captured by cameras connected to the computers via the network such as the Internet.

In a general type of video chat service, the image captured by the single camera of the transmission-sided computer is transmitted from the transmission-sided computer to a server on the network, which provides the video chat service. The server transmits the received images to the reception-sided computer. The server compresses the data quantity of the received images by thinning out the received images as the case may be, depending on a state of the communication line, a state of the reception-sided computer, etc. The reception-sided computer displays the received image on a display device of the reception-sided computer. Further, similarly, the reception-sided computer transmits the images to the transmission-sided computer via the server, while the transmission-sided computer displays the received images on the display device of the transmission-sided computer. Thus, the user of the transmission-sided computer and the user of the reception-sided computer can view the images transmitted mutually from the communication partner computers on the display devices of the self-sided computers.

On the other hand, there is a stereoscopic image generating device which generates the images that can be viewed as stereoscopic vision by making use of parallax between the images captured by two pieces of adjacent cameras. The stereoscopic image generating device generates and displays, for example, in the images captured by the two adjacent cameras, the image captured by one camera as an image for the left eye and the image captured by the other camera as an image for the right eye. The stereoscopic image generating device displays the image for the left eye to the left eye of the viewer and the image for the right eye to the right eye thereof, thereby making the viewer perceive the stereoscopic image.
[Patent document 1] Japanese Patent Application Laid-Open Publication No. 2003-289553
[Patent document 2] Japanese Patent Application Laid-Open Publication No. 2010-62695
[Patent document 3] Japanese Patent Application Laid-Open Publication No. 2004-94639

### SUMMARY

The image transmitted to the reception side from the transmission side and used for the video chat service, is generally one frame of image (moving picture) captured by the single camera. Therefore, the server for providing the video chat service supports transmitting and receiving the image (a two dimensional image, a non-stereoscopic image) captured by the single camera but does not support transmitting and receiving the images (the stereoscopic image) captured by the two cameras. On the other hand, the stereoscopic image makes the viewer feel stereoscopic by use of the two images (the image for the left eye and the image for the right eye). Hence, if the server for providing the video chat service does not support transmitting and receiving the two images, it is difficult to use the stereoscopic image (three dimensional image) employing the images captured by the two cameras for the video chat. The user of the computer, who uses the video chat service, is, however, hard to set the server for providing the video chat service employed by the user himself or herself so as to support the stereoscopic image. Accordingly, it is desirable that even the server for providing the video chat service in which the image (the two dimensional image, the non-stereoscopic image) given from the single camera is transmitted and received, can make use of the stereoscopic image in the video chat service.

Namely, according to a first aspect, an information processing device includes:

a receiving unit to receive image data;

a determining unit to determine whether the image data received by the receiving unit contain an image for three dimensional vision or not;

a converting unit to convert, if the determining unit determines that the image data contain the image for the three dimensional vision, the image data into a stereoscopic image; and

a display unit to display the stereoscopic image converted by the converting unit.

The aspect of the disclosure may be realized in such a way that a program is executed by the information processing device. Namely, a configuration of the disclosure can be specified as a program for making the information processing device execute processes implemented by the respective means in the aspect described above or specified as a recording medium recorded with the program. Further, the configuration of the disclosure may be specified as a method by which the information processing device executes the processes implemented by the respective means.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating an example of an architecture of an information processing system.

FIG. 2 is a diagram illustrating an example of a configuration of a server device.

FIG. 3 is a diagram illustrating an example of a configuration of a transmission-sided terminal.

FIG. 4 is a diagram illustrating an example of a user table.

FIG. 5 is a diagram illustrating an example of a configuration of a reception-sided terminal.

FIG. 6 is a diagram illustrating an example of a hardware configuration of an information processing device.

FIG. 7 is a diagram illustrating an example of an operation sequence of the information processing system.

FIG. 8 is a flowchart illustrating an example of an operation flow of the transmission-sided terminal.

FIG. 9 is a diagram illustrating an example of how the stereoscopic image is converted.

FIG. 10 is a flowchart illustrating an example of an operation flow of the reception-sided terminal.

FIG. 11 is an explanatory diagram illustrating how the image data is decoded and how the stereoscopic image is generated.

FIG. 12 is a diagram illustrating a display example (screen example) on a display device of the reception-sided terminal.

### DESCRIPTION OF EMBODIMENTS

An embodiment will hereinafter be described with reference to the drawings. A configuration in the embodiment is an exemplification, and the present invention is not limited to the configuration in the embodiment of the disclosure.

Herein, the embodiment will be discussed by taking a video chat (picture chat) service for example. The configuration of the disclosure can be applied to the whole of communication devices and communication systems that entail TV telephony, a WEB conference and a TV conference in addition to the video chat. The pictures (images) contain moving pictures (dynamic images).

The following discussion involves using an image for the left eye and an image for the right eye, however, there is no superiority or inferiority between the image for the left eye and the image for the right eye, and these images can be exchanged with each other.

### Example of Architecture

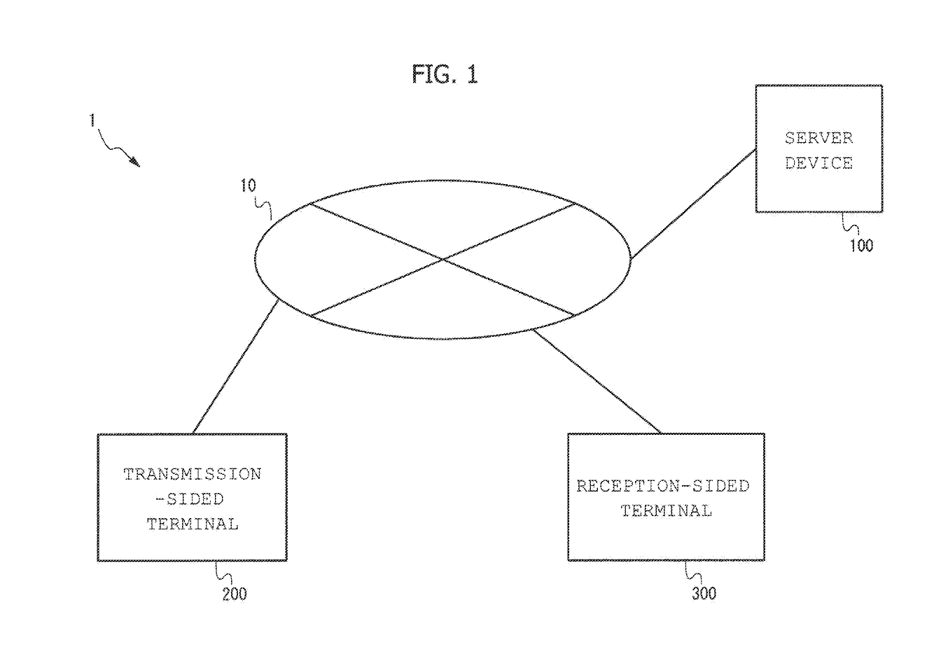

FIG. 1 is a diagram depicting an example of an architecture of an information processing system according to the embodiment. An information processing system 1 in FIG. 1 includes a server device 100, a transmission-sided terminal 200 and a reception-sided terminal 300, which are connected to a network 10. The server device 100 transmits the image transmitted from the transmission-sided terminal 200 to the reception-sided terminal 300. The transmission-sided terminal 200 transmits the image captured by a camera of the transmission-sided terminal 200 to the server device 100. The reception-sided terminal 300 displays the image (video) received from the server device 100 on a display device. The network 10 is exemplified by, e.g., the Internet and a LAN (Local Area Network). The network 10 is not limited to these types of networks. The transmission-sided terminal 200 and the reception-sided terminal 300 are enabled to communicate with each other via the network 10 and the server device 100. Each of the server device 100, the transmission-sided terminal 200 and the reception-sided terminal 300 may have an encrypting/decrypting function of encrypting information such as a password and decrypting the information given from other devices.

In the video chat service etc., the transmission-sided terminal 200 and the reception-sided terminal 300 perform transmitting and receiving the images, mutually. Herein, expediently, the terminal transmitting the image is referred to as the transmission-sided terminal 200, while the terminal receiving the image is referred to as the reception-sided terminal 300, however, the transmission-sided terminal 200 and the reception-sided terminal 300 have the same configuration in principle. Namely, the transmission-sided terminal 200 has the configuration (components) contained in the reception-sided terminal 300, while the reception-sided terminal 300 has the configuration (components) contained in the transmission-sided terminal 200. The transmission-sided terminal 200 operates also as the reception-sided terminal 300, while the reception-sided terminal 300 operates also as the transmission-sided terminal 200.

It is assumed that a user who operates the transmission-sided terminal 200 and a user who operates the reception-sided terminal 300 have operation authority for the video chat service provided by the server device 100 by virtue of IDs, passwords, etc.

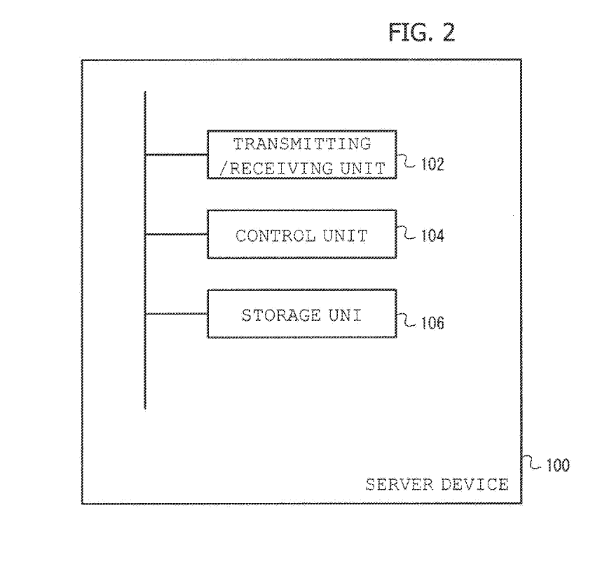

FIG. 2 is a diagram depicting an example of a configuration of the server device. The server device 100 includes a transmitting/deceiving unit 102, a control unit 104 and a storage unit 106.

The server device 100 provides the video chat service to the transmission-sided terminal 200 and the reception-sided terminal 300. The server device 100 transmits image data received from the transmission-sided terminal 200 to the reception-sided terminal 300. The server device 100 has a function of transferring one piece of image in at least one direction (e.g., the direction from the transmission-sided terminal 200 to the reception-sided terminal 300). The server device 100 can authenticate the user of each terminal as a user of the video chat service.

The transmitting/deceiving unit 102 receives image data, voice data, character data, user information, etc., which are transmitted from the transmission-sided terminal 200. Further, the transmitting/deceiving unit 102 transmits the image data, the voice data, the character data, the user information, etc., which has thus been received, to the reception-sided terminal 300. The image data etc. can be transmitted and received as streaming data.

The control unit 104 performs a control operation and an arithmetic operation of the server device 100. The control unit 104, when transmitting the data received from the transmission-sided terminal 200 to the reception-sided terminal 300, extracts an address, stored in the storage unit 106, of the reception-sided terminal 300 on the basis of the user information contained in the data given from the transmission-sided terminal 200. The control unit 104 instructs, based on the extracted address, the transmitting/deceiving unit 102 to transmit the data received from the transmission-sided terminal 200 to the reception-sided terminal 300. The control unit 104 authenticates the user of the transmission-sided terminal 200 and the user of the reception-sided terminal 300 in the video chat service.

The storage unit 106 gets stored with the user information and the address of the reception-sided terminal 300 (or the transmission-sided terminal 200) employed by the user in a way of being associated with each other. Further, the storage unit 106 gets stored with an account table in which a user ID of the user of the video chat service is associated with a password.

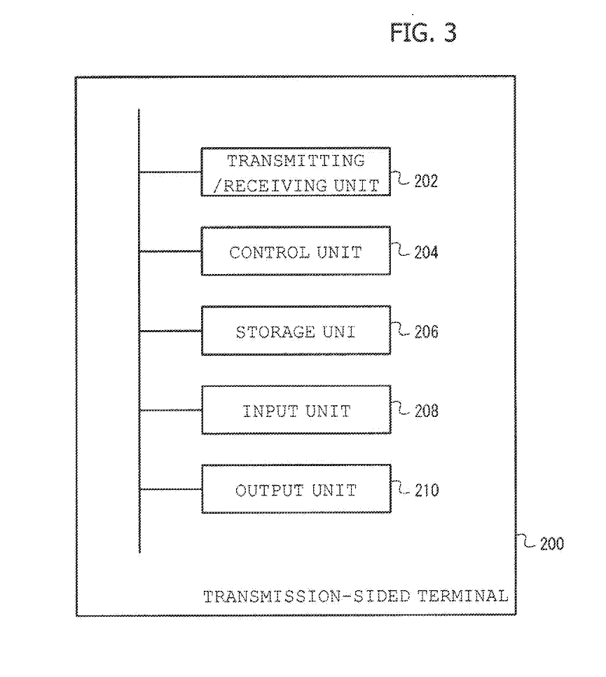

FIG. 3 is a diagram depicting an example of a configuration of the transmission-sided terminal. The transmission-sided terminal 200 includes a transmitting/deceiving unit 202, a control unit 204, a storage unit 206, an input unit 208 and a display unit 210.

The transmitting/deceiving unit 202 transmits the user information of the transmission-sided terminal 200, the user information of the reception-sided terminal 300, the image data, etc. to the server device 100.

The control unit 204 performs the control operation and the arithmetic operation of the transmission-sided terminal 200. The image acquired by the input unit 208 is converted into the image data for transmission. The control unit 204 instructs the transmitting/deceiving unit 202 to transmit the image data etc. to the server device 100.

The storage unit 206 is stored with a user table T100 etc. containing the user information of the reception-sided terminal 300 capable of receiving a stereoscopic image.

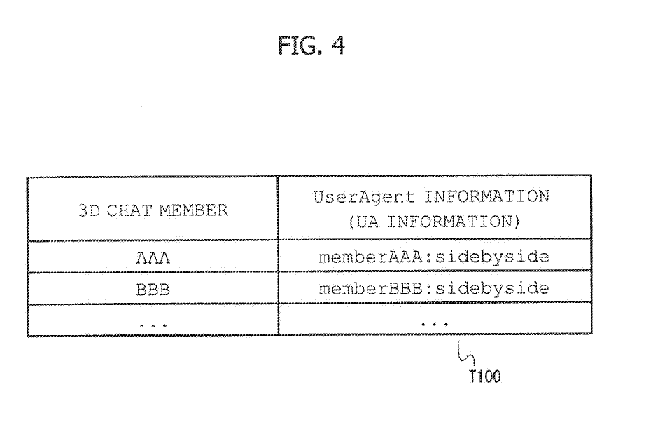

FIG. 4 is a diagram illustrating an example of the user table. The user table T100 in FIG. 4 gets stored with “3D chat member” and “UserAgent information (UA information) in the way of being associated with each other. The “3D chat member” is defined as a user of communication partner terminal capable of performing the video chat based on the stereoscopic image. The UA information contains the user information of the communication partner terminal and information on a stereoscopic image transmission system of the transmission-sided terminal 200. The user information is, e.g., a user ID of the user of the communication partner terminal in the video chat service. Further the UA information may contain information on the user terminal as the communication partner terminal. The UA information may contain items of information such as a file compression method, an encryption method, a name of group to which the user belongs, usable types of images, usable types of voices (sounds), etc. A “chat member” is set as a substitute for the ““3D chat member”, and the “chat member” may contain a user of the communication partner terminal capable of performing the video chat based on the stereoscopic image and a user of the communication partner terminal incapable of performing the video chat based on the stereoscopic image. The user of the communication partner terminal incapable of performing the video chat based on the stereoscopic image is enabled to conduct the video chat based on a general type of two dimensional image. In this case, for example, a specific symbol etc. may be attached to the user name of the chat member capable of performing the video chat based on the stereoscopic image in order to distinguish between availability and non-availability of the video chat based on the stereoscopic image.

The user table T100 may be stored in the storage unit 106 of the server device 100. At this time, the server device 100, after authenticating the user of the transmission-sided terminal 200, transmits the user table T100 to the transmission-sided terminal 200. The transmission-sided terminal 200 stores the information of the received user table T100 in the storage unit 206.

The input unit 208 includes two cameras, a microphone, a keyboard, etc. The two cameras, the microphone, the keyboard, etc. may each be built in or connected to the transmission-sided terminal 200. The two cameras are disposed in a way that enables the stereoscopic image to be captured. The two cameras are installed, e.g., adjacently at a predetermined interval.

The output unit 210 includes a display device, a speaker, etc. The display device, the speaker, etc. may each be built in or connected to the transmission-sided terminal 200.

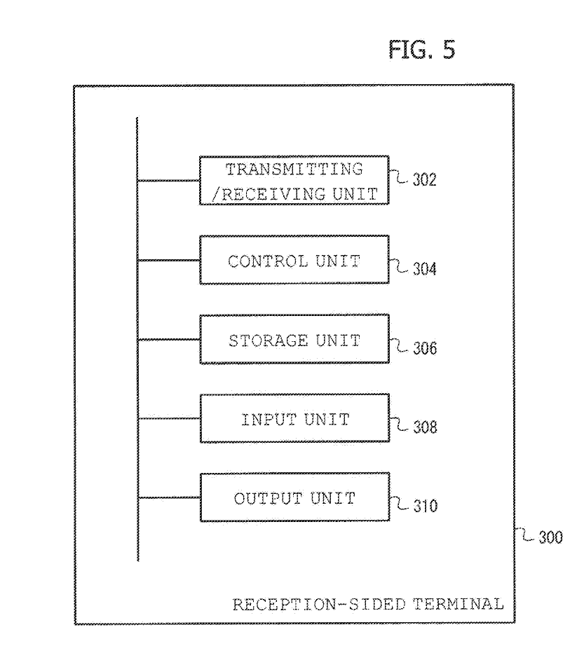

FIG. 5 is a diagram depicting an example of a configuration of the reception-sided terminal. The reception-sided terminal 300 includes a transmitting/receiving unit 302, a control unit 304, a storage unit 306, an input unit 308 and a display unit 310.

The transmitting/receiving unit 302 receives the user information of transmission-sided terminal 200, the user information of the reception-sided terminal 300, the image data, etc. from the from the server device 100.

The control unit 304 performs the control operation and the arithmetic operation of the reception-sided terminal 300. The control unit 304 converts the received image signal into the stereoscopic image and gets the stereoscopic image displayed by the output unit 310. The control unit 304 can operate as a determining unit or a converting unit.

The storage unit 306 is stored with the user information etc. of the transmission-sided terminal 200.

The input unit 308 includes the keyboard etc. The keyboard etc. may be built in or connected to the reception-sided terminal 300. The control unit 304 and the input unit 308 can operate as an accepting unit.

The output unit 310 includes a display device, a speaker, etc. The display device, the speaker, etc. may each be built in or connected to the reception-sided terminal 300. The display device is a display device for the three dimensional vision. The display device for the 3D vision is a display device configured to display the image for the left eye to the left eye of the viewer and the image for the right eye to the right eye thereof, thus making the viewer perceive the three dimensional image. The output unit 310 can operate as a display unit.

The server device 100 can be realized by use of a general-purpose computer such as a personal computer (PC: Personal Computer) or a dedicated computer such as a server machine.

The transmission-sided terminal 200 and the reception-sided terminal 300 can be each realized by employing the dedicated or general-purpose computer such as the PC, a workstation (WS: Work Station), a PDA (Personal Digital Assistant) or by using electronic equipment mounted with the computer. Further, the transmission-sided terminal 200 and the reception-sided terminal 300 can be each realized by use of the dedicated or general-purpose computer such as a smartphone, a mobile phone and a car navigation system or by using the electronic equipment mounted with the computer.

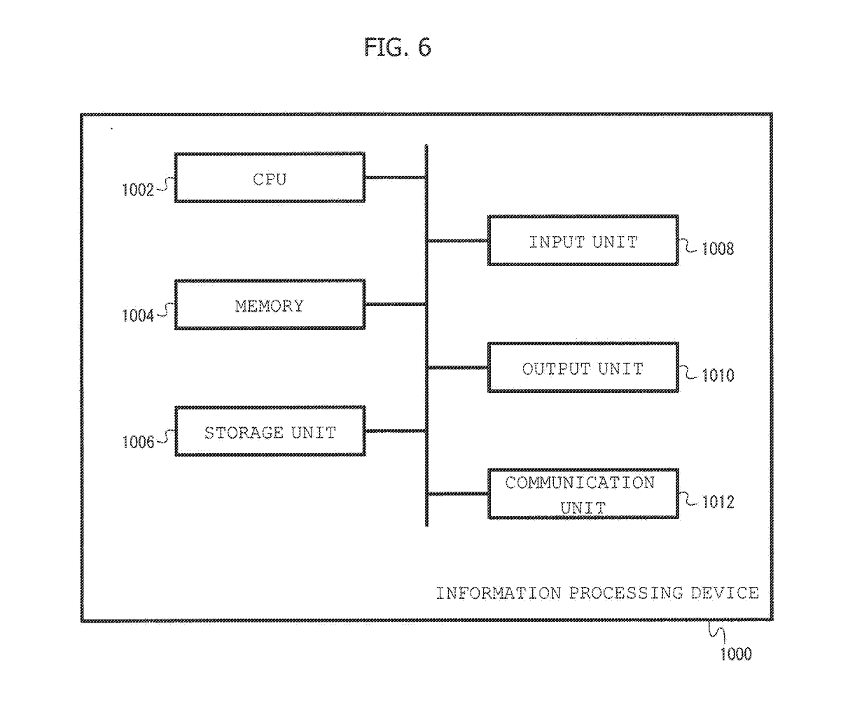

FIG. 6 is a diagram illustrating an example of a hardware configuration of an information processing device. The server device 100, the transmission-sided terminal 200 and the reception-sided terminal 300 are each realized by, e.g., an information processing device 1000 as illustrated in FIG. 6.

The computer, i.e., the information processing device 1000 includes a CPU (Central Processing Unit) 1002, a memory 1004, a storage unit 1006, an input unit 1008, an output unit 1010 and a communication unit 1012.

In the information processing device 1000, the CPU 1002 loads a program stored in the storage unit 1006 into an operation area of the memory 1004 and executes this program, and peripheral devices are controlled through the execution of the program, whereby functions matching with predetermined purposes can be realized.

The CPU 1002 executes processes according to the program stored in the storage unit 1006.

The memory 1004 is a memory in which the CPU 1002 caches the program and the data and also deploys an operation area. The memory 1004 includes, e.g., a RAM (Random Access Memory) and a ROM (Read Only Memory). The memory 1004 is a main storage device.

The storage unit 1006 stores various categories of programs and various items of data on a recording medium in a readable/writable manner. The storage unit 1006 is exemplified such as an EEPROM (Erasable Programmable ROM), a solid-state drive (SSD: Solid State Drive) device and a hard disk drive (HDD: Hard Disk Drive) device. The storage unit 1006 is further exemplified such as a CD (Compact Disc) drive device, a DVD (Digital Versatile Disk) drive device, a +R/+RW drive device and a HD DVD (High-Definition Digital Versatile Disk) drive device or a BD (Blu-ray Disk) drive device. Moreover, the recording medium is exemplified such as a silicon disc including a nonvolatile semiconductor memory (flash memory), a hard disk, a CD, a DVD, a +R/+RW, a HD DVD or a BD. The CD is exemplified by a CD-R (Recordable), a CD-RW (Rewritable) and a CD-ROM. The DVD is exemplified by, a DVD-R and a DVD-RAM (Random Access Memory). The BD is exemplified by a BD-R, a BD-RE (Rewritable) and a BD-ROM. Furthermore, the storage unit 1006 can include removable mediums, i.e., portable recording mediums. The removable medium is a USB (Universal Serial Bus) memory or a disc recording medium such as the CD and the DVD. The storage unit 1006 is a secondary storage device.

The memory 1004 and the storage unit 1006 are computer-readable recording mediums.

The input unit 1008 accepts an operating instruction etc. from the user etc. The input unit 1008 is an input device such as a keyboard, a pointing device, a wireless remote controller, a microphone, a digital still camera and a digital video camera. The CPU 1002 is notified of the information inputted from the input unit 1008.

The output unit 1010 outputs the data processed by the CPU 1002 and the data stored in the memory 1004. The output unit 1010 is an output device such as a CRT (Cathode Ray Tube) display, an LCD (Liquid Crystal Display), a PDP (Plasma Display Panel), an EL (Electroluminescence) panel, a printer and a speaker.

The communication unit 1012 transmits and receives the data to and from external devices. The communication unit 1012 is connected to the external devices via, e.g., signal lines. The external devices are, e.g., other information processing devices and storage devices. The communication unit 1012 is exemplified such as a LAN (Local Area Network) interface board and a wireless communication circuit for wireless communications.

In the information processing device 1000, the storage unit 1006 is stored with an operating system (OS), the variety of programs, a variety of tables, etc.

The OS is software which acts as an intermediary between software (applications, middleware, firmware, etc.) and the hardware and manages memory spaces, files, processes and tasks. The OS includes the communication interfaces. The communication interfaces are programs for transferring and receiving the data to and from other external devices connected via the communication unit 1012.

In the computer realizing the server device 100, a processor loads the program stored in the secondary storage device into the main storage device and then executes the program, thereby realizing a function as the control unit 104. On the other hand, the storage unit 106 is configured in a storage area of the main storage device or the secondary storage device. The transmitting/receiving unit 102 can be realized as the CPU 1002 and the communication unit 1012.

In the computer realizing the transmission-sided terminal 200, the processor loads the program stored in the secondary storage device into the main storage device and then executes the program, thereby realizing a function as the control unit 204. On the other hand, the storage unit 206 is configured in the storage area of the main storage device or the secondary storage device. The input unit 208 and the output unit 210 can be realized as the input unit 1008 and the output unit 1010, respectively. The transmitting/receiving unit 202 can be realized by way of the CPU 1002 and the communication unit 1012.

In the computer realizing the reception-sided terminal 300, the processor loads the program stored in the secondary storage device into the main storage device and then executes the program, thereby realizing a function as the control unit 304. On the other hand, the storage unit 306 is configured in the storage area of the main storage device or the secondary storage device. The input unit 308 and the output unit 310 can be realized as the input unit 1008 and the output unit 1010, respectively. The transmitting/receiving unit 302 can be realized by way of the CPU 1002 and the communication unit 1012.

A series of processes can be executed by the hardware and can be also executed by the software.

Steps of describing the programs contain, as a matter of course, processes that are executed in time-series along the described sequence and processes that are executed in parallel or individually without being necessarily processed in time-series.

### Operational Example

<Whole>

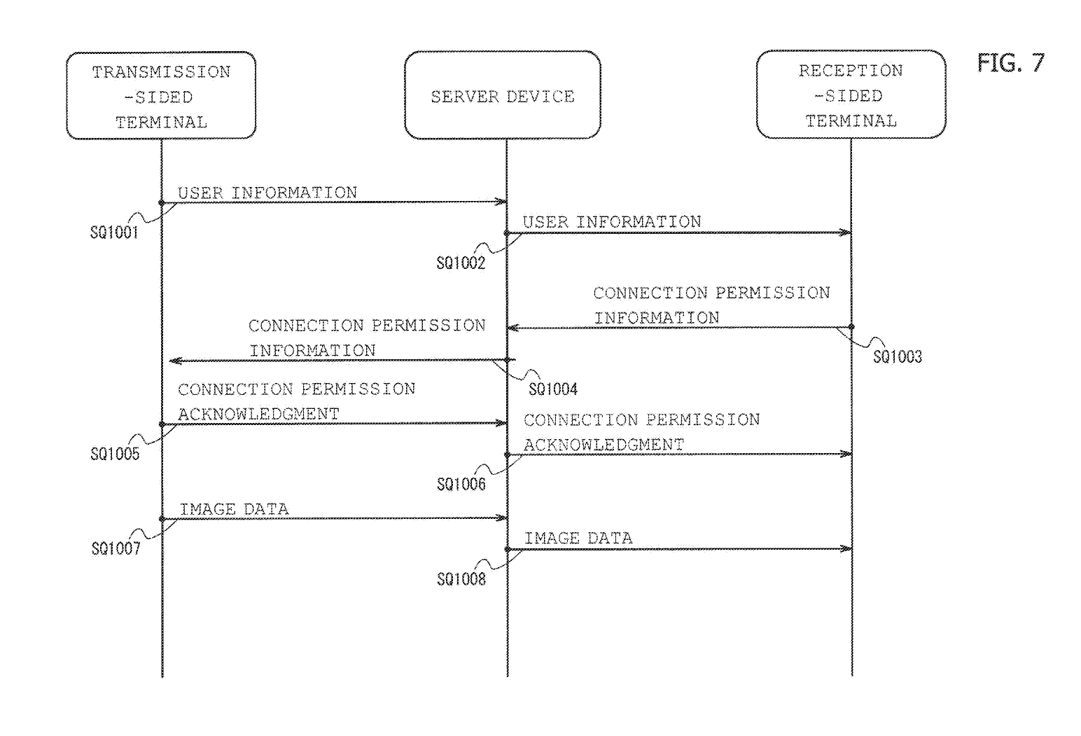

FIG. 7 is a sequence diagram illustrating an example of an operation sequence of the information processing system in the embodiment. In the information processing system 1, the reception-sided terminal 300 permits a connection requested from the transmission-sided terminal 200, whereby the transmission-sided terminal 200 transmits the data of the stereoscopic image to the reception-sided terminal 300 via the server device 100.

A start of the operation sequence in FIG. 7 is triggered by such an event that the server device 100 authenticates the user of the transmission-sided terminal 200 as the user of the video chat service on the server device 100.

The authentication is conducted by the server device 100 in a way that uses, e.g., the user ID and the password which are inputted by the user of the transmission-sided terminal 200. When the transmission-sided terminal 200 transmits the user ID and the password to the server device 100, the control unit 104 of the server device 100 checks whether or not a 2-tuple of the user ID and the password exists in an account table stored in the storage unit 106. If existing therein, the control unit 104 of the server device 100 makes “Authentication OK” determination. Whereas if not, the control unit 104 of the server device 100 makes “Authentication NG” determination. At this time, the server device 100 notifies the transmission-sided terminal 200 of an authentication result. The server device 100 can similarly authenticate the user of the reception-sided terminal 300.

The transmission-sided terminal 200, upon receiving the authentication result of “Authentication OK” from the server device 100, displays the user of the communication partner terminal enabled to perform the video chat based on the stereoscopic image to the user (of the self-terminal). The user of the communication partner terminal enabled to perform the video chat based on the stereoscopic image is stored as the “3D chat member” in the user table T100. The control unit 204 of the transmission-sided terminal 200 extracts the “3D chat member” from the user table T100 stored in the storage unit 206, and displays this “3D chat member” on the display device. The transmission-sided terminal 200 prompts the user to select the user of a desired communication partner terminal from within the displayed users. The transmission-sided terminal 200 may display the user of the communication partner terminal enabled to perform the video chat based on the stereoscopic image and the user of the communication partner terminal disabled from performing the video chat based on the stereoscopic image. The transmission-sided terminal 200, in the case of transmitting the image to the user of the communication partner terminal disabled from performing the video chat based on the stereoscopic image, transmits not the stereoscopic image but the general type of two dimensional image (e.g., the image captured by the single camera).

When the user of the communication partner terminal is selected, the transmission-sided terminal 200 transmits the user information of the reception-sided terminal 300 together with the user information of the transmission-sided terminal 200 to the server device 100 (SQ1001). The user information of the transmission-sided terminal 200 may contain the information of the transmission-sided terminal 200. The user information of the reception-sided terminal 300 may contain the information of the reception-sided terminal 300. The user information of the transmission-sided terminal 200 or the user information of the reception-sided terminal 300 may contain the information on the stereoscopic image transmission system of the transmission-sided terminal 200. Herein, it is assumed by way of one example that the user information of the reception-sided terminal 300 contains the stereoscopic image transmission system of the transmission-sided terminal 200. The user information of the transmission-sided terminal 200 is, e.g., a user ID of the user of the transmission-sided terminal 200. The user information of the reception-sided terminal 300 is, for example, UserAgent information (UA information) in the user table T100. The UA information contains the information on the user of the communication partner terminal and information on the stereoscopic image transmission system (transmission system information) of the transmission-sided terminal 200.

The server device 100 transmits, to the reception-sided terminal 300, the user information of the transmission-sided terminal 200 and the user information of the reception-sided terminal 300, which are received from the transmission-sided terminal 200 (SQ1002). The server device 100 specifies the reception-sided terminal 300 as a destination from the user information of the reception-sided terminal 300. The server device 100 specifies the reception-sided terminal 300 as the destination from, e.g., a table in which an address of the reception-sided terminal 300 and the user of the reception-sided terminal 300 are associated with each other. The table is stored in the storage unit 106 of the server device 100. The user information of the reception-sided terminal 300 contains the information on the stereoscopic image transmission system of the transmission-sided terminal 200, however, the server device 100 may not recognize that the user information contains the information on the stereoscopic image transmission system of the transmission-sided terminal 200.

The reception-sided terminal 300 receives the user information of the transmission-sided terminal 200 and the user information of the reception-sided terminal 300 from the server device 100. The user information of the reception-sided terminal 300 contains the information on the stereoscopic image transmission system of the transmission-sided terminal 200. The reception-sided terminal 300 recognizes that the user information of the reception-sided terminal 300 contains the information on the stereoscopic image transmission system of the transmission-sided terminal 200. Namely, the reception-sided terminal 300 recognizes that the user of the transmission-sided terminal 200 makes a request for the communications based on the stereoscopic image.

The reception-sided terminal 300 notifies the user of the reception-sided terminal 300 of a purport that the user of the transmission-sided terminal 200 makes the request for the communications based on the stereoscopic image. If the user of the reception-sided terminal 300 does not permit the communications, the reception-sided terminal 300 transmits the information purporting that the user does not permit the communications to the transmission-sided terminal 200 via the server device 100. At this time, the user of the transmission-sided terminal 200 and the user of the reception-sided terminal 300 are disabled from communicating with each other.

If the user of the reception-sided terminal 300 permits the communications, the reception-sided terminal 300 transmits, to the server device 100, connection permission information defined as the information purporting that the communications with the transmission-sided terminal 200 are permitted (SQ1003). The server device 100, upon receiving the connection permission information from the reception-sided terminal 300, transmits the connection permission information to the transmission-sided terminal 200 (SQ1004).

The transmission-sided terminal 200, when receiving the connection permission information from the reception-sided terminal 300, transmits connection permission acknowledgement to the server device 100 toward (as addressed to) the reception-sided terminal 300 (SQ1005). The server device 100, upon receiving the connection permission acknowledgement, transmits this connection permission acknowledgement to the reception-sided terminal 300 (SQ1006). The reception-sided terminal 300, when receiving the connection permission acknowledgement from the transmission-sided terminal 200, recognizes that the image data containing the image for the 3D vision is to be transmitted from the transmission-sided terminal 200.

The transmission-sided terminal 200, when transmitting the connection permission acknowledgement to the reception-sided terminal 300, prepares the stereoscopic image that is transmitted to the reception-sided terminal 300. The transmission-sided terminal 200 converts the stereoscopic image to be transmitted to the reception-sided terminal 300 into the image data for the transmission. The transmission-sided terminal 200 converts, e.g., the stereoscopic image into the image data (the data containing the image for the 3D vision) disposed side by side (side-by-side image data) on a per-frame (per-image) basis. The transmission-sided terminal 200 converts the image into such a type of image data that one frame contains the image for the left eye and the image for the right eye. Namely, the transmission-sided terminal 200 synthesizes the image for the left eye and the image for the right eye into a single piece of image data. The thus-synthesized image data is the data containing the image for the 3D vision. One frame contains the image for the left eye and the image for the right eye, whereby the reception-sided terminal 300 can, even when the server device 100 thins out the frames for compressing the data or the like, reproduce the transmitted image as the stereoscopic image. The synthesized image data is the same data as the image data of the 2D image.

The transmission-sided terminal 200 transmits the converted image data for the transmission to the server device 100 toward (as addressed to) the reception-sided terminal 300 (SQ1007). This image data is the image data on one screen (one picture). The server device 100, when receiving the image data etc., transmits the image data etc. to the reception-sided terminal 300 (SQ1008). The transmission-sided terminal 200 or the server device 100 can encode the image data.

The reception-sided terminal 300 receives the image data etc. from the server device 100. The reception-sided terminal 300 decodes the image data and displays the thus-decoded stereoscopic image on the display device capable of displaying the stereoscopic image. Further, the reception-sided terminal 300, as a result of decoding the image data, when determining that the image data does not contain the image for the 3D vision, does not display the image data as the stereoscopic image. The reception-sided terminal 300, when receiving the voice data and the character data together with the image data, reproduces these categories of data as well as displaying the stereoscopic image.

Further, if the stereoscopic image is the dynamic image (moving picture), the transmission-sided terminal 200 converts the stereoscopic image into the image data containing the stereoscopic image sequentially (e.g., on the per-frame basis), and transmits the image data toward the reception-sided terminal 300. The reception-sided terminal 300 decodes the received image data sequentially (e.g., on the per-frame basis), and displays the stereoscopic image on the display device. At this time, the transmission-sided terminal 200 generates and thus transmits the image data as streaming data. Moreover, the reception-sided terminal 300 receives and thus reproduces the image containing the image for the 3D vision as the streaming data.

<Transmission-Sided Terminal>

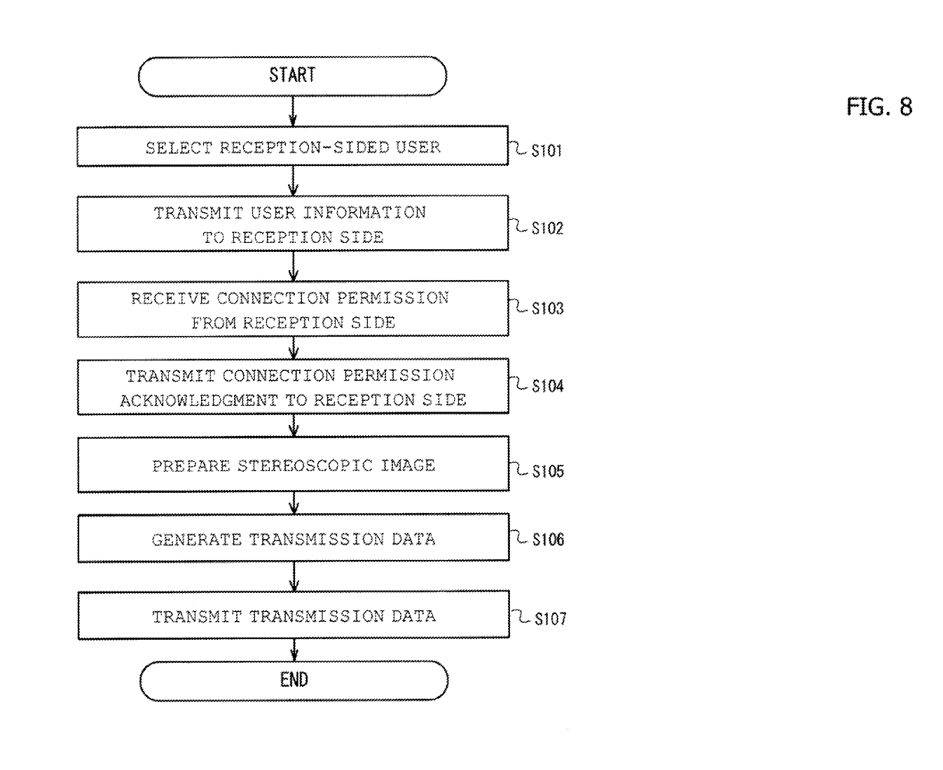

FIG. 8 is a flowchart illustrating an operation flow of the transmission-sided terminal. A start of the operation flow in FIG. 8 is triggered by such an event that the server device 100 authenticates the user of the transmission-sided terminal 200 as the user of the video chat service on the server device 100.

The transmission-sided terminal 200, when the user is authenticated by the server device 100, displays the user of the communication partner terminal enabled to perform the video chat based on the stereoscopic image to the user (of the self-terminal). The user of the communication partner terminal enabled to perform the video chat based on the stereoscopic image is stored as “3D chat member” in the user table T100. The control unit 204 of the transmission-sided terminal 200 extracts the “3D chat member” from the user table T100 stored in the storage unit 206, and displays the extracted “3D chat member” on the display device. The transmission-sided terminal 200 prompts the user to select the user of a desired communication partner terminal from within the displayed users (S101). In the example of the user table T100 in FIG. 4, the stereoscopic image transmission system of the transmission-sided terminal 200 is a “sidebyside (side-by-side)” system. The user table T100 may be provided from the server device 100 after being authenticated. The user table T100 provided from the server device 100 may contain the users enabled to perform the communications at the present point of time but may not contain the users disabled from performing the communications at the present point of time. The users enabled to perform the communications at the present point of time are, e.g., the users who are authenticated by the server device 100 at the present point of time as the users of the video chat service.

When the user of the communication partner terminal is selected, the transmitting/receiving unit 202 of the transmission-sided terminal 200 transmits the user information of the user of the desired communication partner terminal, i.e., the reception-sided terminal 300 together with the user information of the transmission-sided terminal 200 via the server device 100 to the reception-sided terminal 300 (S102). The transmission-sided terminal 200, when transmitting the user information etc., stands by for the connection permission transmitted from the reception-sided terminal 300.

The transmission-sided terminal 200, upon receiving the connection permission information purporting the permission of the communications from the reception-sided terminal 300 (S103), generates the connection permission acknowledgment. The connection permission acknowledgment is information used for the transmission-sided terminal 200 to notify the reception-sided terminal 300 that the connection permission is received. The transmission-sided terminal 200 transmits the connection permission acknowledgment toward the reception-sided terminal 300 (S104).

The transmission-sided terminal 200, when transmitting the connection permission acknowledgment to the reception-sided terminal 300, starts preparing the stereoscopic image that is transmitted to the reception-sided terminal 300 (S105). The transmission-sided terminal 200 starts capturing the images as the stereoscopic image, which is transmitted to the reception-sided terminal 300, by use of, e.g., the two cameras of the input unit 208. The image captured by one of the two cameras is the image for the left eye, and the image captured by the other camera is the image for the right eye. Further, for instance, the user of the transmission-sided terminal 200 may select the stereoscopic image that is stored in the storage unit 206 etc. as the stereoscopic image that is transmitted to the reception-sided terminal 300.

The transmission-sided terminal 200 converts the stereoscopic image to be transmitted to the reception-sided terminal 300 into the image data for the transmission (S106). The transmission-sided terminal 200 converts the two images, i.e., the image for the left eye and the image for the right eye, into one piece of image data for the transmission. The transmission-sided terminal 200 converts, e.g., the stereoscopic image into the side-by-side image data on the per-frame basis. The image data converted herein is recognized as one piece of image data on the server device 100. The transmission-sided terminal 200 may, in the case of transmitting the general type of 2D image (the image captured by one camera), set the image for the right eye as the image data.

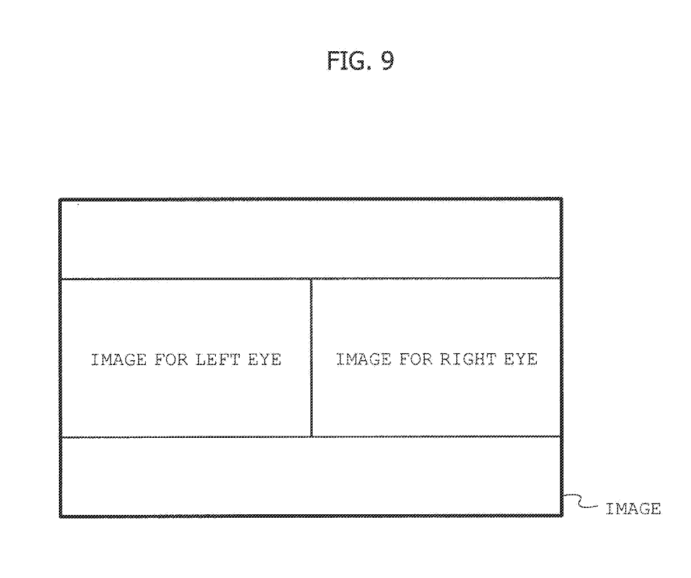

FIG. 9 is a diagram illustrating an example of how the stereoscopic image is converted. FIG. 9 illustrates the example in which the stereoscopic image containing the image for the left eye and the image for the right eye is converted into the image data of one piece of side-by-side image (synthesized image). In the thus-converted image, the image for the left eye is disposed in a left half of the image frame, while the image for the right eye is disposed in a right half of the image frame. The images in FIG. 9 correspond to one frame of the image (stereoscopic image) converted in the side-by-side format. The layout of the images is not limited to the example in FIG. 9. For example, the image for the left eye may spread over the whole of the left half of the image frame, while the image for the right eye may spread over the whole of the right half of the image frame.

Referring back to FIG. 8, the transmission-sided terminal 200 transmits the converted image data to the server device 100 toward (as addressed to) the reception-sided terminal 300 (S107). The transmission-sided terminal 200 may also transmit the voice data, the character data, etc. together with the image data. The voice data is voice data acquired by, e.g., the microphone of the input unit 208 together with the images captured by the cameras. Both of the image data and the voice data contain time information by which synchronization can be taken when reproduced. The character data is character information inputted by the user of the transmission-sided terminal 200 through, e.g., the keyboard etc. of the input unit 208. These multiple items of data are reproduced on the reception-sided terminal 300.

If the stereoscopic image is the dynamic image (moving picture), the transmission-sided terminal 200 converts the stereoscopic image into the image data containing the images for the 3D vision sequentially (e.g., on the per-frame basis), and transmits the converted image data toward the reception-sided terminal 300. Namely, in this case, the processes from step S105 onward are repeated.

As in the operation flow of FIG. 8, the transmission-sided terminal 200 transmits the image data to the reception-sided terminal 300.

<Reception-Sided Terminal>

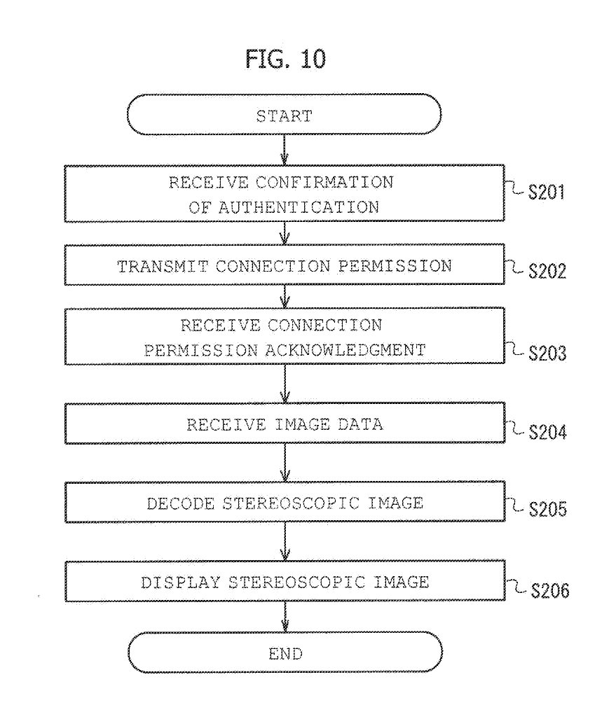

FIG. 10 is a flowchart illustrating an operation flow of the reception-sided terminal. A start of the operation flow in FIG. 10 is triggered by such an event that the server device 100 authenticates, e.g., the user of the reception-sided terminal 300 as the user of the video chat service on the server device 100.

The reception-sided terminal 300 receives the user information of the transmission-sided terminal 200 and the user information of the reception-sided terminal 300 from the server device 100 (S201). The reception-sided terminal 300 receives these pieces of user information, thereby recognizing that the user of the transmission-sided terminal 200 desires to communicate with the user of the reception-sided terminal 300. The user information of the reception-sided terminal 300 contains the information on the stereoscopic image transmission system of the transmission-sided terminal 200. The reception-sided terminal 300 extracts the information on the stereoscopic image transmission system of the transmission-sided terminal 200 from the user information of the reception-sided terminal 300. The user information of the reception-sided terminal 300 contains the information on the stereoscopic image transmission system of the transmission-sided terminal 200, whereby the reception-sided terminal 300 recognizes that the transmission-sided terminal 200 is to transmit the stereoscopic image by this transmission system. The stereoscopic image transmission system is, e.g., the “side-by-side” system. The stereoscopic image transmission system is not, however, limited to the “side-by-side” system. For example, the image for the left eye and the image for the right eye may be synthesized in a way that disposes the image for the left eye and the image for the right eye, e.g., on a per-raw basis on the screen.

The reception-sided terminal 300 notifies the user of the reception-sided terminal 300 of a purport that the user of the transmission-sided terminal 200 requests the communications based on the stereoscopic image. The reception-sided terminal 300 displays “the user of the transmission-sided terminal 200 requests the communications based on the stereoscopic image” on, e.g., the display device of the output unit 310. The reception-sided terminal 300 prompts the user of the reception-sided terminal 300 to makes selection as to whether the communications based on the stereoscopic image with the user of the transmission-sided terminal 200, who desires the communications, are permitted or not. If the communications are not permitted, the reception-sided terminal 300 transmits the information purporting that the communications are not permitted to the transmission-sided terminal 200 via the server device 100. At this time, the user of the transmission-sided terminal 200 is disabled from communicating with the user of the reception-sided terminal 300.

Whereas if the communications are permitted, the reception-sided terminal 300 transmits the connection permission information, defined as the information purporting that the communications with the transmission-sided terminal 200 are permitted, to the transmission-sided terminal 200 via the server device 100 (S202). The transmission-sided terminal 200, when receiving the connection permission information, transmits the connection permission acknowledgment to the reception-sided terminal 300. The connection permission acknowledgment is the information indicating that the transmission-sided terminal 200 has received the connection permission information. The reception-sided terminal 300 receives the connection permission acknowledgment from the transmission-sided terminal 200 (S203).

The reception-sided terminal 300 receives the image data etc. from the server device 100 (S204). The reception-sided terminal 300 may receive, for instance, the voice data and the character data together with the image data. Both of the image data and the voice data contain the time information by which the synchronization can be taken when reproduced.

The reception-sided terminal 300 generates display data of the stereoscopic image to be displayed on the display device by decoding the image data (S205).

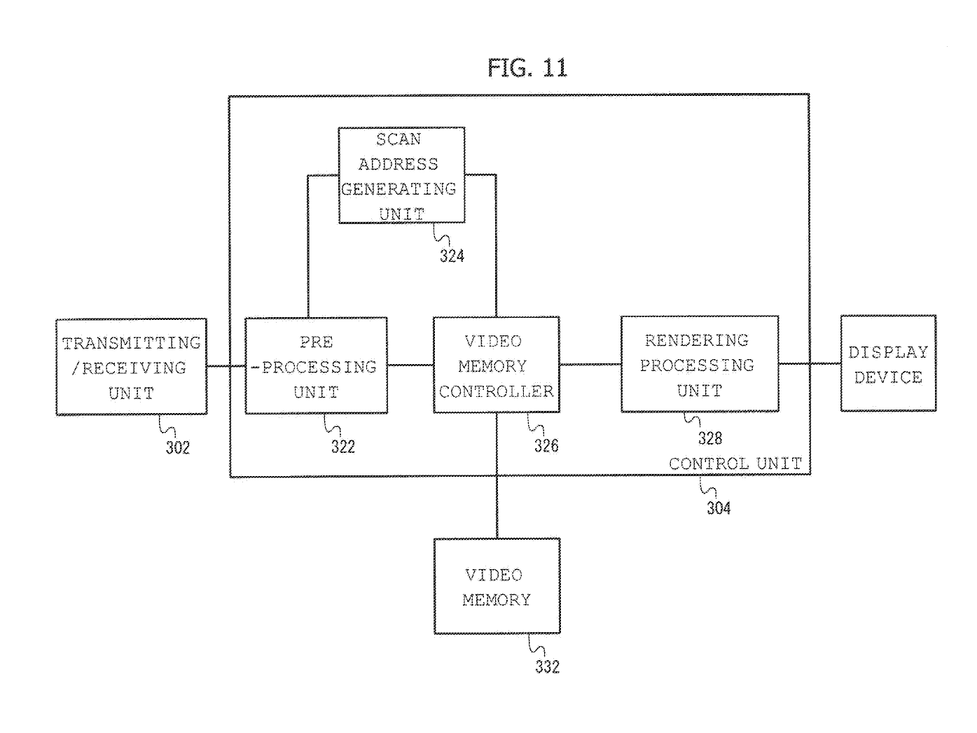

FIG. 11 is an explanatory diagram illustrating how the image data is decoded and how the stereoscopic image is generated. The control unit 304 includes a pre-processing unit 322, a scan address generating unit 324, a video memory controller 326 and a rendering processing unit 328. A video memory 332 is included in the storage unit 306. The pre-processing unit 322 can operate as a determining unit. The video memory controller 326 and the rendering processing unit 328 can operate as a converting unit.

The transmitting/receiving unit 302, upon receiving the image data, sends the image data to the pre-processing unit 322. The pre-processing unit 322 decodes the image data. The image data has already been encoded by the transmission-sided terminal 200 or the server device 100.

The pre-processing unit 322 extracts a synchronous signal from the image data and transmits the synchronous signal to the scan address generating unit 324. The synchronous signal is a signal for taking the synchronization between the image data and the voice data. If the image data is not synchronized with the voice data and when outputting the image and the voice, a time-lag occurs, which causes the user of the reception-sided terminal 300 as a viewer to feel unnatural.

The pre-processing unit 322 checks the transmission system of the stereoscopic image that is transmitted from the transmission-sided terminal 200. The stereoscopic image transmission system is checked in step S201. It is herein assumed that the stereoscopic image transmission system is the “sidebyside” system. In the “sidebyside” system, as in FIG. 9, the image for the left eye is disposed in the left half of the 1-frame image, while the image for the right eye is disposed in the right half.

The pre-processing unit 322 extracts the images of the received image data. The pre-processing unit 322 determines whether or not the images contain the image for the 3D vision. If the stereoscopic image is based on the “sidebyside” system, the left half (a portion corresponding to the image for the left eye) of the image is similar to the right half (a portion corresponding to the image for the right eye) thereof.

Then, the pre-processing unit 322 can determine, in a manner that follows, whether the image for the 3D vision is contained or not. The pre-processing unit 322 separates, based on the stereoscopic image transmission system, the received images into the image for the left eye and the image for the right eye. The pre-processing unit 322 superposes the left half (the portion corresponding to the image for the left eye) of the extracted image on the right half (the portion corresponding to the image for the right eye) thereof in the same position, thereby taking differences between pixel values. The pre-processing unit 322 can, if a sum of the differences between the pixel values is less than a predetermined value, determine that the images contain the image for the 3D vision.

Furthermore, there is a case of being incapable of determining whether the image for the left eye and the image for the right eye sufficiently contain the image for the 3D vision or not, depending on the superposition in the same position due to influence of parallax existing in the images. Such being the case, the pre-processing unit 322 may determine whether or not the image for the 3D vision is contained in the following manner. The pre-processing unit 322 superposes the left half (the portion corresponding to the image for the left eye) of the image on the right half (the portion corresponding to the image for the right eye) thereof in the same position, thereby taking the differences between the pixel values of both of images. Moreover, the pre-processing unit 322 moves the left half of the image in parallel, and similarly takes the differences in respective positions. An arithmetic unit 120 can, if a sum of the differences is less than the predetermined value in any one of the positions, determine that the images contain the image for the 3D vision. A moving quantity of the parallel movement is herein set less than a predetermined quantity. The predetermined quantity is set to a quantity with which the image for the left eye and the image for the right eye can be recognized generically as the image for the 3D vision. The determination as to whether the image for the 3D vision is contained or not is not limited to what has been given herein.

The pre-processing unit 322, when determining that the images contain the image for the 3D vision, sends the images to the video memory controller 326. The video controller 326 separates the images into the left halves (the portion corresponding to the images for the left eye) and the right halves (the portion corresponding to the image for the right eye), in which the video memory 332 gets temporarily stored with the left halves as the images for the left eye and the right halves as the images for the right eye. The video memory controller 326 sequentially transmits the images for the left eye and the images for the right eye, which are stored in the video memory 332, to the rendering processing unit 328. The rendering processing unit 328 generates the image for the left eye and the data of the image for the right eye as the data that are displayed in the form of the stereoscopic image on the display device.

Further, the pre-processing unit 322, when determining that the images do not contain the image for the 3D vision, sends the images to the video controller 326. The video controller 326 temporarily stores the video memory 332 with the images as they are without separating the image. The video memory controller 326 sequentially transmits the images stored in the video memory 332 to the rendering processing unit 328. The rendering processing unit 328 generates the transmitted images as the data that are displayed in the form of the general type of 2D image on the display device.

The scan address generating unit 324 generates, based on the synchronous signal extracted by the pre-processing unit 322, a scan address signal and supplies the generated signal to the video memory controller 326. The video memory controller 326 transmits, based on the synchronous signal, the images to the rendering processing unit 328.

Referring back to FIG. 10, the reception-sided terminal 300 displays the stereoscopic image generated by the control unit 304 on the display device capable of displaying the stereoscopic image (S206). Further, the reception-sided terminal 300 decodes the received voice data and outputs the decoded voice from the speaker of the output unit 110. The reception-sided terminal 300 outputs the voice in synchronization with the stereoscopic image. The reception-sided terminal 300 decodes the received character data, and displays the decoded character information on the display device.

Moreover, if the stereoscopic image is the dynamic image (moving picture), the reception-sided terminal 300 decodes the received image data sequentially (e.g., on the per-frame basis), and displays the stereoscopic image on the display device. Namely, in this case, the processes from step S204 onward are iterated.

As in the operation flow of FIG. 10, the reception-sided terminal 300 receives the image data and displays the stereoscopic image. Further, the reception-sided terminal 300, whereas if the received image data is not the stereoscopic image, displays the image in the form of the general type of 2D image.

### Modified Example

The server device 100 transmits the data etc. given from the transmission-sided terminal 200 to a plurality of reception-sided terminals 300, and the information processing system 1 can be thereby applied to a TV conference system etc. in which three or more terminals participate. Further similarly, the information processing system 1 can be applied to such a video streaming broadcast that the plurality of reception-sided terminals exist for one single transmission-sided terminal 200.

Furthermore, the transmission-sided terminal 200 may not transmit the stereoscopic image transmission system. The reception-sided terminal 300 receives the image data in the same way as explained in step S205 and in FIG. 11, on which occasion the pre-processing unit 322 can determine whether the image data contain the image for the 3D vision or not. At this time, the image data, which are to be transmitted, may be assumed to be of the “sidebyside” system. Further, the pre-processing unit 322 may separate, on the presumption of some transmission systems, the received images into the images for the left eye and the images for the right eye, and may determine whether the image data contain the image for the 3D vision or not. At this time, the pre-processing unit 322 determines, if it is determined that the image for the 3D vision is contained even in the case of one transmission system, that the image data contain the image for the 3D vision.

The reception-sided terminal 300 may, when displaying the stereoscopic image on the display device, get the user of the reception-sided terminal 300 to make the selection as to whether the stereoscopic image is displayed or not. At this time, the reception-sided terminal 300 displays a purport of making the selection as to “whether the stereoscopic image is displayed or not” on the display device. If the user of the reception-sided terminal 300 selects not to display the stereoscopic image, the reception-sided terminal 300 can extract, e.g., the image for the right eye from the image data and can display the image for the right eye (not the stereoscopic image) as the general type of image on the display device. With this contrivance, if the user does not desire to view the stereoscopic image, it is feasible not to display the stereoscopic image. Further, an available contrivance is that a “stereoscopic image changeover” button is displayed on the display device, and the user can arbitrarily change over the display of the “stereoscopic image” and the display of the “two dimensional image”.

When the pre-processing unit 322 of the reception-sided terminal 300 determines that the transmitted image data do not contain the image for the 3D vision, the data may be deleted.

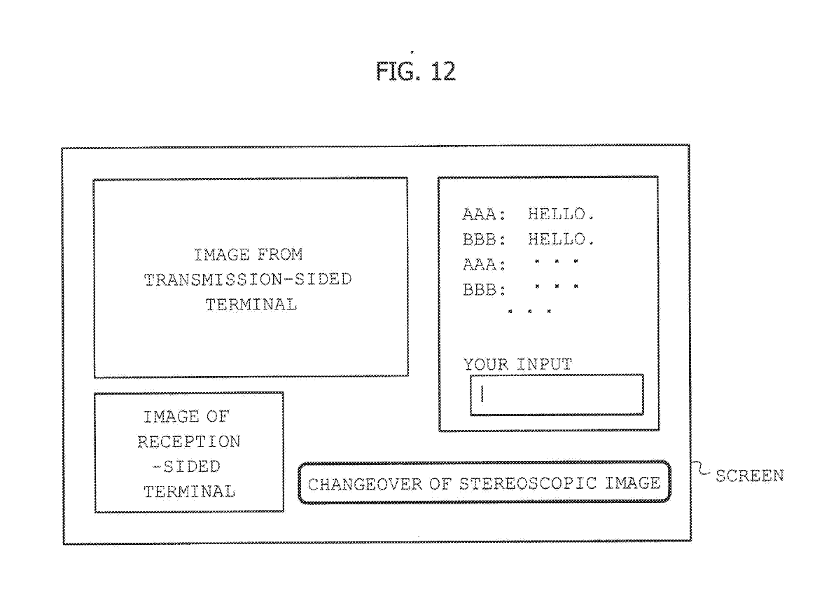

FIG. 12 is a diagram illustrating a display example (screen example) of the display device of the reception-sided terminal. In the example of FIG. 12, the display device displays, on the screen, the image given from the transmission-sided terminal 200, the image of the self-device (reception-sided terminal 300), a character data area, a character input area and the “stereoscopic image changeover” button. The user of the reception-sided terminal 300 selects the “stereoscopic image changeover” button, thereby changing over the display of the “stereoscopic image” and the display of the “two dimensional image”. The selection of the button can be accepted through the pointing device, the keyboard, etc. of the input unit 308.

The reception-sided terminal 300, on the occasion of displaying the two dimensional image, displays, e.g., the image for the right eye of the stereoscopic image, thus displaying the two dimensional image. At this time, the video memory controller 326 sequentially transmits the images for the right eye, which are stored in the video memory 332, to the rendering processing unit 328. The rendering processing unit 328 generates the image for the right eye as the data to be displayed in the form of the two dimensional image on the display device.

The reception-sided terminal 300, even when receiving the stereoscopic image and if the user of the reception-sided terminal 300 does not desire to display the stereoscopic image, can display (a part of) the stereoscopic image as the two dimensional image.

(Effects of Embodiment)

The transmission-sided terminal 200 prepares the stereoscopic image containing the image for the left eye and the image for the right eye to be transmitted to the reception-sided terminal 300. The transmission-sided terminal 200 converts the image for the left eye and the image for the right eye into one piece of image data (e.g., the side-by-side image data). The transmission-sided terminal 200 transmits the converted image data to the reception-sided terminal 300 via the server device 100. The server device 100 transmits the image data transmitted from the transmission-sided terminal 200 as one piece of image data to the reception-sided terminal 300. The reception-sided terminal 300 determines whether the received image data contain the image for the 3D vision or not. The reception-sided terminal 300, if the image for the 3D vision is contained therein, converts the image data into the stereoscopic image and displays this image on the display device.

According to the system in the embodiment, even when the server device 100 does not support the distribution of the stereoscopic image, the stereoscopic image can be transmitted and received by use of the image data of the two dimensional image between the transmission-sided terminal 200 and the reception-sided terminal 300. That is, according to the system in the embodiment, the transmission-sided terminal 200 can transmit the stereoscopic image to the reception-sided terminal 300 without changing the configuration of the server device 100 which provides the existing video chat service.

[Computer-Readable Recording Medium]

A program for making a computer, other machines and devices (which will hereinafter be referred to as the computer etc.) realize any one of the functions can be recorded on a recording medium readable by the computer etc. Then, the computer etc. is made to read and execute the program on this recording medium, whereby the function thereof can be provided.

Herein, the recording medium readable by the computer etc. connotes a recording medium capable of accumulating information such as data and programs electrically, magnetically, optically, mechanically or by chemical action, which can be read from the computer etc. Each of these mediums may be provided with components such as a CPU and a memory which configure the computer, in which the CPU may be made to execute the program.

Further, among these recording mediums, for example, a flexible disc, a magneto-optic disc, a CD-ROM, a CD-R/W, a DVD, a DAT, an 8 mm tape, a memory card, etc. are given as those removable from the computer.

Moreover, a hard disc, a ROM, etc. are given as the recording mediums fixed within the computer etc.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device comprising:
a receiving unit to receive image data;
a determining unit to determine whether the image data received by the receiving unit contain an image for three dimensional vision or not;
a converting unit to convert, if the determining unit determines that the image data contain the image for the three dimensional vision, the image data into a stereoscopic image; and
a display unit to display the stereoscopic image converted by the converting unit.

2. The information processing device according to claim 1, further comprising an accepting unit to accept as to whether the stereoscopic image is displayed or not,
wherein if the determining unit determines that the image data contain the image for the three dimensional vision and when the accepting unit accepts a purport that the stereoscopic image is not displayed, the converting unit extracts one of an image for the left eye and an image for the right eye that are contained in the converted stereoscopic image, and
the display unit displays the image extracted by the converting unit.

3. The information processing device according to claim 1, wherein the receiving unit receives transmission system information, and
the converting unit converts the image data into the stereoscopic image on the basis of the transmission system information.

4. An information processing method by which a computer executes:
receiving image data;
determining whether the image data contain an image for three dimensional vision or not;
converting, if determining that the image data contain the image for the three dimensional vision, the image data into a stereoscopic image; and
getting a display device to display the converted stereoscopic image.

5. The information processing method according to claim 4, wherein the computer further executes:
accepting as to whether the stereoscopic image is displayed or not;
extracting, if determining that the image data contain the image for the three dimensional vision and when accepting a purport that the stereoscopic image is not displayed, one of an image for the left eye and an image for the right eye that are contained in the converted stereoscopic image, and
displaying the image which is extracted.

6. The information processing method according to claim 4, wherein the computer further executes:
receiving transmission system information; and
converting the image data into the stereoscopic image on the basis of the transmission system information.

7. A non-transitory computer readable storage medium storing an information processing program for a computer to execute:
receiving image data;
determining whether the image data contain an image for three dimensional vision or not;
converting, if determining that the image data contain the image for the three dimensional vision, the image data into a stereoscopic image; and
getting a display device to display the converted stereoscopic image.

8. The non-transitory computer readable storage medium storing an information processing program according to claim 7, wherein the computer further executes:
accepting as to whether the stereoscopic image is displayed or not;
extracting, if determining that the image data contain the image for the three dimensional vision and when accepting a purport that the stereoscopic image is not displayed, one of an image for the left eye and an image for the right eye that are contained in the converted stereoscopic image, and
displaying the image which is extracted.

9. The non-transitory computer readable storage medium storing an information processing program according to claim 7, wherein the computer further executes:
receiving transmission system information; and
converting the image data into the stereoscopic image on the basis of the transmission system information.
